(19) United States
(12) Patent Application Publication
(10) Pub. No.: US 2023/0351413 A1
(43) Pub. Date: Nov. 2, 2023

(54) ANTI-COUNTERFEITING AND ENCRYPTION SYSTEM AND METHOD FOR CARTRIDGE, COMPUTER-READABLE MEMORY MEDIUM AND AEROSOL GENERATING DEVICE

(71) Applicant: CHANGZHOU PATENT ELECTRONIC TECHNOLOGY CO., LTD, Changzhou (CN)

(72) Inventor: Weihua QIU, Changzhou (CN)

(73) Assignee: CHANGZHOU PATENT ELECTRONIC TECHNOLOGY CO., LTD, Changzhou (CN)

(21) Appl. No.: 18/338,377

(22) Filed: Jun. 21, 2023

Related U.S. Application Data
(63) Continuation of application No. PCT/CN2021/128856, filed on Nov. 5, 2021.

(30) Foreign Application Priority Data
Dec. 31, 2020 (CN) 202011643993.6

(51) Int. Cl. G06Q 30/018; H04L 9/32; A24F 40/53

(52) U.S. Cl. CPC G06Q 30/0185; H04L 9/3234; A24F 40/53

(57) ABSTRACT

An anti-counterfeiting and encryption system and method for a cartridge, the method including: by means of an encryption unit, encrypting an ID information and a basic information of each cartridge, and storing the encrypted data in a first memory chip of a corresponding cartridge; when the cartridge is inserted into an smoking appliance for the first time, reading and decrypting, by means of a processing chip of smoking appliance, the information stored in the first memory chip of the cartridge so as to obtain the ID information, binding the ID information and encoding information, and storing the bound information in the first memory chip of the cartridge and a second memory chip of the smoking appliance at the same time; reading the bound formation in the second memory chip of the smoking appliance, and sending the bound information to a background server to determine whether the cartridge is valid.

### CROSS-REFERENCE TO RELATED APPLICATIONS

The present disclosure is the continuation application of International Patent Application No. PCT/CN2021/128856, filed on Nov. 5, 2021, which claims priority to Chinese Patent Application No. 202011643993.6, filed on Dec. 31, 2020. All of the aforementioned patent applications are hereby incorporated by reference in their entireties.

### TECHNICAL FIELD

The present disclosure relates to the technical field of an anti-counterfeiting for cartridge, in particular to an anti-counterfeiting and encryption system and a method for a cartridge, a computer-readable memory medium and an aerosol generating device.

### BACKGROUND

The aerosol generating device with replaceable cartridges has become very popular because of its small size and portability. Therefore, this prompts individual third-party manufacturers to use lower costs to imitate corresponding cartridges in pursuit of profits. When these cheap cartridges enter the market, they will form malicious competition for genuine cartridges, and at the same time, the health of users will not be guaranteed. Therefore, the emergence of anti-counterfeiting encrypted cartridges can effectively suppress this problem.

### SUMMARY

In view of the technical defects and technical drawbacks existing in the prior art, the embodiments of the present disclose provide an anti-counterfeiting and encryption system and method for a cartridge that overcomes the above-mentioned problems or at least partially solves the above-mentioned problems. The specific solutions are as follows:

As the first aspect of the present disclose, an anti-counterfeiting and encryption system for a cartridge is provided, the system includes an encryption unit, a terminal APP, a background server, a first memory chip set in the cartridge, a processing chip and a second memory chip set in the smoking appliance; the encryption unit is configured to encrypt an ID information and a basic information of each cartridge based on an encryption algorithm, and store an encrypted data in the first memory chip corresponding to the cartridge, the processing chip is preset with encoding information corresponding to the smoking appliance and a decryption algorithm corresponding to the encryption algorithm, the smoking appliance provided with a communication module for establishing a communication connection with the terminal APP;
the processing chip configured to read and decrypt a stored information in the first memory chip of the cartridge when the cartridge is inserted into the smoking appliance for the first time, so as to obtain the ID information, bind the ID information with the encoding information of the smoking appliance through a specific algorithm, and simultaneously store the binding information in the first memory chip of the cartridge and the second memory chip of the smoking appliance;
after connecting to the smoking appliance, the terminal APP configured to read the binding information in the second memory chip of the smoking appliance, and send the binding information to the background server;
the background server configured to determine whether the cartridge is valid based on the binding information.

In one embodiment, background server determine whether the cartridge is valid based on the binding information, specifically includes:
acquiring the ID information and the encoding information based on the binding information, if there are two or more coded information bound to the ID information, judging that the cartridge is invalid, and sending an early warning message that the cartridge is invalid to the terminal APP.

In one embodiment, the processing chip is also configured to read the stored information in the first memory chip when the cartridge is inserted into the smoking appliance, if an encoding information of a non-current smoking appliance exists in the stored information, control the smoking appliance not to perform a cigarette lighting operation.

In one embodiment, the background server stores ID information of all cartridge and encoding information of all smoking appliance, and the background server is also configured to: obtain the ID information and the encoding information based on the binding information, and respectively compare the ID information and the encoding information with the all ID information and the all encoding information stored in the background server, and send the comparison result to the terminal APP.

In one embodiment, the smoking appliance further includes an unbinding module, the unbinding module is configured to unbind the cartridge and the smoking appliance based on the user's request when the cartridge is inserted into the smoking appliance, and clear the binding information stored in the first memory chip of the cartridge and the second memory chip of the smoking appliance by the processing chip after unbinding.

As a second aspect of the present disclose, an anti-counterfeiting and encryption method for a cartridge is provided, the method including:
encrypting an ID information and a basic information of each cartridge based on an encryption algorithm, and storing an encrypted data in the first memory chip corresponding to the cartridge through the encryption unit;
when the cartridge is inserted into a smoking appliance for the first time, a stored information in the first memory chip of the cartridge read and decrypted by a processing chip of the smoking appliance to obtain the ID information, binding the ID information and a encoding information of the smoking appliance through a specific algorithm, and simultaneously storing a binding information in the first memory chip of the cartridge and the second memory chip of the smoking appliance;
through the terminal APP connected to the smoking appliance, reading the binding information in the second memory chip of the smoking appliance, and sent the binding information to the background server to determine whether the cigarette cartridge is valid through the background server.
   Further, wherein the background server determines whether the cartridge is valid includes:
the background server obtaining the ID information and the encoding information based on the binding information, if there are two or more encoding information bound to the ID information, determining that the cartridge is invalid, and sending an early warning message that the cartridge is invalid to the terminal APP.

In one embodiment, wherein the method further includes: when the cartridge is inserted into the smoking appliance, reading the stored information in the first memory chip through the processing chip of the smoking appliance, if an encoding information of a non-current smoking appliance exists in the stored information, controlling the smoking appliance not to perform a cigarette lighting operation.

In one embodiment, the background server stores ID information of all the cartridge and encoding information of all smoking appliance, and the method further includes: the background server obtaining the ID information and the encoding information based on the binding information, respectively comparing the ID information and the encoding information with all the ID information and all the encoding information stored in the background server, and sending the comparison result to the terminal APP.

In one embodiment, the method further includes: when the cartridge is inserted into the smoking appliance, an unbinding operation of the cartridge and the smoking appliance performed based on the user's request through an unbinding module; and clearing the binding information stored in the first memory chip of the cartridge and the second memory chip of the smoking appliance by the processing chip after unbinding.

In a third aspect, a computer-readable memory medium is provided, one or more instructions are stored in the computer-readable memory medium, when the one or more instructions are executed by the processor in the terminal, the anti-counterfeiting and encryption system method of the cartridge according to any optional embodiment of the second aspect is realized.

In a fourth aspect, an aerosol generating device is provided, and the aerosol generating device includes:
a memory and a processor;
at least one program instruction is stored in the memory;
the processor, by loading and executing the at least one program instruction, realizes the control method of the aerosol generating device according to any optional embodiment of the second aspect.

The present disclose has the following beneficial effects;

In the present disclose, the ID information and the basic information of each cartridge are encrypted based on an encryption algorithm and then stored in the first memory chip of the cartridge, through specific encryption algorithms and a key, the security of stored information is guaranteed. At the same time, the corresponding decryption algorithm is preset in the processing chip of the smoking appliance, when the cartridge is inserted into the smoking appliance, read and decrypt the stored information in the first memory chip of the cartridge to obtain the ID information, and bind the ID information with the encoding information of the smoking appliance through a specific algorithm, the binding information is stored in the first memory chip of the cartridge and the second memory chip of the smoking appliance at the same time, and after connecting with the terminal APP, the binding information is sent to the background server for the background server to judge the authenticity and validity of the cartridge.

### BRIEF DESCRIPTION OF THE DRAWINGS

FIG. 1 is a frame diagram of an anti-counterfeiting and encryption system for a cartridge provided by an embodiment of the present disclose;

FIG. 2 is a flowchart of an anti-counterfeiting and encryption method for a cartridge provided by an embodiment of the present disclose.

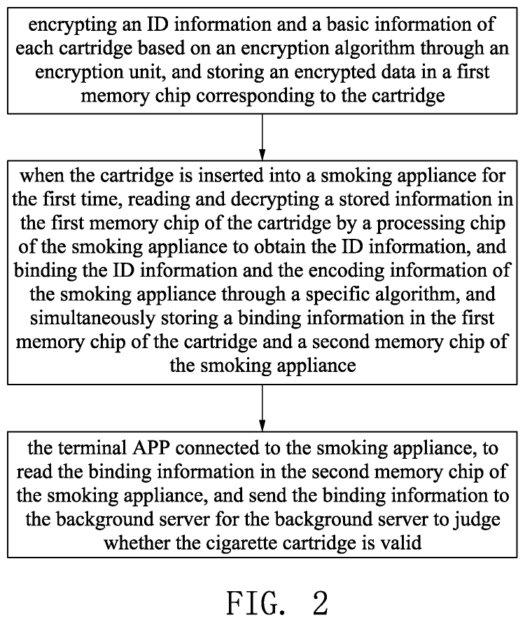

### DETAILED DESCRIPTION OF PREFERRED EMBODIMENTS

The technical solutions in the embodiments of the present disclose will be clearly and completely described below with reference to the accompanying drawings in the embodiments of the present disclose. Obviously, the described embodiments are only a part of the present disclose, but not all of the embodiments. Based on the embodiments of the present disclose, all other embodiments obtained by those of ordinary skill in the art without creative efforts shall fall within the protection scope of the present disclose.

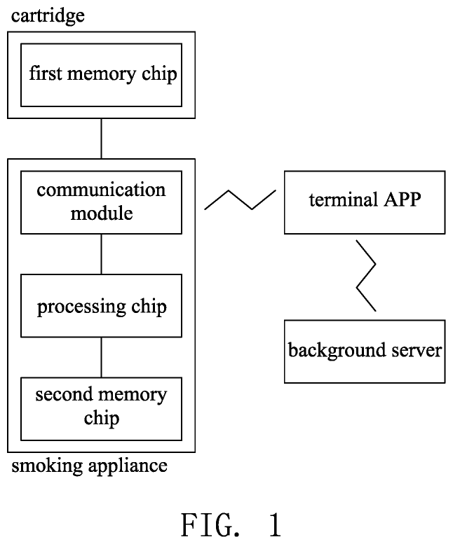

As shown in FIG. 1, as the first embodiment of the present disclose, an anti-counterfeiting and encryption system for a cartridge is provided, the system includes an encryption unit, a terminal APP, a background server, a first memory chip set in the cartridge, a processing chip and a second memory chip provided in a smoking appliance. The encryption unit is configured to encrypt the ID information and basic information of each cartridge based on an encryption algorithm, and store the encrypted data in the first memory chip corresponding to the cartridge. The processing chip is preset with encoding information corresponding to the smoking appliance and a decryption algorithm corresponding to the encryption algorithm. The smoking appliance is provided with a communication module for establishing a communication connection with the terminal APP. Wherein, the communication module can be a Bluetooth module, a WIFI module or other communication modules, and the smoking appliance in this embodiment refers to a battery device.

The processing chip is configured to read and decrypt the stored information in the first memory chip of the cartridge when the cartridge is inserted into the smoking appliance for the first time, so as to obtain the ID information, and bind the ID information with the encoding information of the smoking appliance through a specific algorithm; simultaneously store the binding information in the first memory chip of the cartridge and the second memory chip of the smoking appliance;
the terminal APP is configured to read the binding information in the second memory chip of the smoking appliance after being connected with the smoking appliance, and send the binding information to the background server;
the background servers configured for determining whether the cartridge is valid based on the binding information.

In the present disclose, the ID information and basic information of each cartridge are encrypted based on an encryption algorithm and then stored in the first memory chip of the cartridge; through specific encryption algorithms and keys, the security of stored information is guaranteed. At the same time, the corresponding decryption algorithm is preset in the processing chip of the smoking appliance; when the cartridge is inserted into the smoking appliance, read and decrypt the stored information in the first memory chip of the cartridge to obtain the ID information, and bind the ID information with the coding information of the smoking appliance through a specific algorithm. The binding information is stored in the first memory chip of the cartridge and the second memory chip of the smoking appliance at the same time, and after connecting with the terminal APP, the binding information is sent to the background server for the background server to determine the authenticity and validity of the cartridge.

Wherein, the encryption unit is located inside the manufacturer, before each cartridge is ejected from the factory, the ID information and the basic information of each cartridge will be encrypted based on an encryption algorithm and stored in the first memory chip. The encryption algorithm is defined by the manufacturer itself or constructed with the help of relevant algorithm experts to solve the problem that it is easy to be decrypted by using a shared algorithm. For example, the data has a total of 10 Byte, it is agreed that the last digit (the tenth digit) is the decryption digit, then the encrypted data is formed by adding the tenth data to the first 9 data respectively to obtain 9 new data, plus the tenth digit, a total of 10 data is the encrypted data, decryption is to subtract the tenth data from the first nine data to get the original data.

Optionally, the background server determine whether the cartridge is valid based on the binding information, specifically includes:
acquiring the ID information and the encoding information from the binding information, if there are two or more encoding information bound to the ID information, it is determined that the cartridge is invalid, and an early warning message that the cartridge is invalid is sent to the terminal APP.

In the above embodiment, if the cartridge has been used by others in other places, the binding information will be recorded in the first memory chip of the cartridge, by determining whether there are two or more encoding information bound to the ID information, it can be determined whether the cartridge has been used, if it has been used, it is determined that the cartridge is invalid, and an early warning message is sent to the terminal APP to remind the user that the cartridge is invalid and there is a security problem.

Optionally, the processing chip is also used to read the stored information in the first memory chip when the cartridge is inserted into the smoking appliance, if there is encoding information of non-current smoking appliance in the stored information, it means that the cartridge has been bound elsewhere, it is determined that the cartridge may have been used by other people in other places, so as to control the smoking appliance not to perform cigarette lighting operation, to protect the safety of the user.

In the above embodiment, when the cartridge is inserted into the smoking appliance, the processing chip reads the binding information in the first memory chip, if the encoding information in the binding information is not the encoding information of the current smoking appliance, it means that the cartridge has been bound elsewhere, determining that the cartridge may have been used by other people in other places, so as to control the smoking appliance not to perform cigarette lighting operation, to protect the safety of users.

Optionally, the background server stores ID information of all cartridge and encoding information of all smoking appliances, and the background server are also used for: obtaining the ID information and the encoding information based on the binding information, compare the ID information and the encoding information with all the ID information and encoding information stored in the background server, and send the comparison result to terminal APP.

In the above embodiment, by comparing the ID information and the encoding information with all the ID information and all the encoding information stored in the background server, determine whether the cartridges and smoking appliance are the cartridge and smoking appliance recorded in the background server, if the ID information and the coding information are not one of the ID information and encoding information stored in the background server, it is determined that the cartridge or smoking appliance is produced by a third-party manufacturer.

Optionally, the smoking appliance also includes an unbinding module, the unbinding module is configured to unbind the cartridge and the smoking appliance based on the user's request when the cartridge is inserted into the smoking appliance, and clear the binding information stored in the first memory chip of the cartridge and the second memory chip of the smoking appliance by the processing chip after unbinding.

In addition, it can also set the cartridges to be bound to a fixed number of smoking appliances, when the cartridge needs to be unbound from a certain smoking appliance, it needs to be unbound in the corresponding smoking appliance, and then replace the smoking appliance. However, there are all binding records in the background server. When the binding number reaches the upper limit, it will no longer be output and used.

As a second aspect of the present disclose, an anti-counterfeiting and encryption method for a cartridge is provided, the method including:
encrypting an ID information and a basic information of each cartridge based on an encryption algorithm through an encryption unit, and storing an encrypted data in a first memory chip corresponding to the cartridge;
when the cartridge is inserted into a smoking appliance for the first time, reading and decrypting a stored information in the first memory chip of the cartridge by a processing chip of the smoking appliance to obtain the ID information, and binding the ID information and the encoding information of the smoking appliance through a specific algorithm, and simultaneously storing a binding information in the first memory chip of the cartridge and a second memory chip of the smoking appliance;
the terminal APP connected to the smoking appliance, to read the binding information in the second memory chip of the smoking appliance, and send the binding information to the background server for the background server to judge whether the cigarette cartridge is valid.
wherein, the communication module can be the Bluetooth module, the WIFI module or other communication modules, the data transmission between cartridges and smoking appliance is based on the communication method supported by the memory chip, and transmission methods such as IIC or SPI can be used.

In the present disclose, the ID information and basic information of each cartridge are encrypted based on an encryption algorithm and then stored in the first memory chip of the cartridge, through specific encryption algorithms and keys, the security of stored information is guaranteed. At the same time, the corresponding decryption algorithm is preset in the processing chip of the smoking appliance, when the cartridge is inserted into the smoking appliance, read and decrypt the stored information in the first memory chip of the cartridge to obtain the ID information, and bind the ID information with the coding information of the smoking appliance through a specific algorithm, the binding information is stored in the first memory chip of the cartridge and the second memory chip of the smoking appliance at the same time, and after connecting with the terminal APP, the binding information is sent to the background server for the background server to judge the authenticity and validity of the cartridge.

Wherein, the encryption algorithm is an algorithm defined by the manufacturer itself or an algorithm constructed with the help of relevant algorithm experts, so as to solve the problem that it is easy to be decrypted by using a shared algorithm. For example, the data has a total of 10 Byte, and it is agreed that the last bit (the tenth bit) is the decryption bit, then the encrypted data is formed by adding the tenth bit data to the first nine data respectively to obtain 9 new data, plus the tenth digit, a total of 10 data is the encrypted data, decryption is to subtract the tenth data from the first nine data to get the original data.

Optionally, the background server judging whether the cartridge is valid as follows:
the background server obtaining the ID information and the encoding information based on the binding information, if there are two or more coded information bound to the ID information, determining that the cartridge is invalid, and sending an early warning message that the cartridge is invalid to the terminal APP.

In the above embodiment, if the cartridge has been used by others in other places, the binding information will be recorded in the first memory chip of the cartridge, by determine whether there are two or more encoding information bound to the ID information, it can be judged whether the cartridge has been used, if it has been used, it is judged that the cartridge is invalid, and an early warning message is sent to the terminal APP to remind the user that the cartridge is invalid and there is a security problem.

Optionally, the method further includes: when the cartridge is inserted into the smoking appliance, reading the binding information in the first memory chip through the processing chip of the smoking appliance, and obtaining the encoding information from the binding information; if an encoding information of a non-current smoking appliance exists in the stored information, controlling the smoking appliance not to perform a cigarette lighting operation.

In the above embodiment, when the cartridge is inserted into the smoking appliance, the stored information in the first memory chip is read by the processing chip, if there is encoding information of non-current smoking appliance in the stored information, it means that the cartridge has been bound elsewhere, it is judged that the cartridge may have been used by other people in other places, so as to control the smoking appliance from performing cigarette lighting operation and protect the safety of the user.

Optionally, the background server stores the ID information of all cartridges and the coding information of all smoking appliance, and the method also includes: the background server obtains the ID information and the encoding information based on the binding information, comparing the ID information and the encoding information with all the ID information and encoding information stored in the background server, and sending the comparison result to the terminal APP.

In the above-mentioned embodiment, by respectively comparing the ID information and the coding information with all the ID information and all the encoding information stored in the background server, it is judged whether the cartridge and smoking appliance are the cartridges and smoking appliance recorded in the background server; if the ID information and the coding information are not compared with all the ID information and coding information stored in the background server, it is judged that the cartridge or smoking appliance is produced by a third-party manufacturer.

Optionally, the method further includes: when the cartridge is inserted into the smoking appliance, the unbinding operation of the cartridge and the smoking appliance is performed based on the user's request through the unbinding module, and clear the binding information stored in the first memory chip of the cartridge and the second memory chip of the smoking appliance by the processing chip after unbinding.

In addition, you can also set the cartridges to be bound to a fixed number of smoking appliances, when the cartridge needs to be unbound from a certain smoking appliance, it needs to be unbound in the corresponding smoking appliance, and then replace the smoking appliance. However, there are all binding records in the background server. When the binding reaches the upper limit, it will no longer be output and used.

An embodiment of the present disclose also provides a computer-readable memory medium, one or more instructions are stored in the computer-readable memory medium, when the one or more instructions are executed by the electronic cigarette or the processor in the terminal, the anti-counterfeiting and encryption method of the cartridge involved in any of the above-mentioned embodiments is realized.

An embodiment of the present disclose also provides an aerosol generating device, the aerosol generating device comprises: a memory and processor; at least one program instruction is stored in the memory; the processor realizes the anti-counterfeiting and encryption method of the cartridge involved in any of the above-mentioned embodiments by loading and executing the at least one program instruction.

The above descriptions are only preferred embodiments of the present disclose, and are not intended to limit the present disclose, any modifications, equivalent replacements, improvements, etc. made within the spirit and principles of the present disclose shall be included within the protection scope of the present disclose.

What is claimed is:

1. An anti-counterfeiting and encryption system for a cartridge comprising: an encryption unit, a terminal APP, a background server, a first memory chip set in the cartridge, and a processing chip and a second memory chip set in a smoking appliance;
the encryption unit configured to encrypt an ID information and a basic information of each cartridge based on an encryption algorithm, and store an encrypted data in the first memory chip corresponding to the cartridge, the processing chip preset with an encoding information corresponding to the smoking appliance and a decryption algorithm corresponding to the encryption algorithm, the smoking appliance provided with a communication module for establishing a communication connection with the terminal APP;
the processing chip configured to read and decrypt a stored information in the first memory chip of the cartridge when the cartridge is inserted into the smoking appliance for the first time, so as to obtain the ID information, and bind the ID information with the encoding information of the smoking appliance through a specific algorithm, and simultaneously store the binding information in the first memory chip of the cartridge and the second memory chip of the smoking appliance;
after connecting to the smoking appliance, the terminal APP configured to read the binding information in the second memory chip of the smoking appliance, and send the binding information to the background server;
the background server configured to determine whether the cartridge is valid based on the binding information.

2. The anti-counterfeiting and encryption system for the cartridge according to claim 1, wherein the background server configured to determine whether the cartridge is valid based on the binding information, specifically comprises:
acquiring the ID information and the encoding information based on the binding information, if there are two or more encoding information bound to the ID information, determining that the cartridge is invalid, and sending an early warning message that the cartridge is invalid to the terminal APP.

3. The anti-counterfeiting and encryption system for the cartridge according to claim 1, wherein the processing chip is also configured to read the stored information in the first memory chip when the cartridge is inserted into the smoking appliance, if an encoding information of a non-current smoking appliance exists in the stored information, control the smoking appliance not to perform a cigarette lighting operation.

4. The anti-counterfeiting and encryption system for the cartridge according to claim 1, wherein the background server stores ID information of all cartridge and encoding information of all smoking appliance, and the background server is also configured to: obtain the ID information and the encoding information based on the binding information, and respectively compare the ID information and the encoding information with the all ID information and the all encoding information stored in the background server, and send the comparison result to the terminal APP.

5. The anti-counterfeiting and encryption system for the cartridge according to claim 1, wherein the smoking appliance further comprises an unbinding module, the unbinding module is configured to unbind the cartridge and the smoking appliance based on the user's request when the cartridge is inserted into the smoking appliance, and clear the binding information stored in the first memory chip of the cartridge and the second memory chip of the smoking appliance by the processing chip after unbinding.

6. An anti-counterfeiting and encryption method for a cartridge, comprising:
encrypting an ID information and a basic information of each cartridge based on an encryption algorithm, and storing an encrypted data in the first memory chip corresponding to the cartridge through an encryption unit;
when the cartridge is inserted into a smoking appliance for the first time, a stored information in the first memory chip of the cartridge read and decrypted by a processing chip of the smoking appliance to obtain the ID information, binding the ID information and a encoding information of the smoking appliance through a specific algorithm, and simultaneously storing a binding information in the first memory chip of the cartridge and a second memory chip of the smoking appliance;
through the terminal APP connected to the smoking appliance, reading the binding information in the second memory chip of the smoking appliance, and sent the binding information to the background server to determine whether the cigarette cartridge is valid through the background server.

7. The anti-counterfeiting and encryption method for the cartridge according to claim 6, wherein the background server determining whether the cartridge is valid comprises:
the background server obtaining the ID information and the encoding information based on the binding information, if there are two or more encoding information bound to the ID information, determining that the cartridge is invalid, and sending an early warning message that the cartridge is invalid to the terminal APP.

8. The anti-counterfeiting and encryption method for the cartridge according to claim 6, wherein the method further comprises: when the cartridge is inserted into the smoking appliance, reading the stored information in the first memory chip through the processing chip of the smoking appliance, if an encoding information of a non-current smoking appliance exists in the stored information, controlling the smoking appliance not to perform a cigarette lighting operation.

9. The anti-counterfeiting and encryption method for the cartridge according to claim 6, wherein the background server stores ID information of all the cartridge and encoding information of all smoking appliance, and the method further comprises: the background server obtaining the ID information and the encoding information based on the binding information, respectively comparing the ID information and the encoding information with all the ID information and all the encoding information stored in the background server, and sending the comparison result to the terminal APP.

10. The anti-counterfeiting and encryption method for the cartridge according to claim 6, wherein the method further comprises: when the cartridge is inserted into the smoking appliance, an unbinding operation of the cartridge and the smoking appliance performed based on the user's request through an unbinding module; and clearing the binding information stored in the first memory chip of the cartridge and the second memory chip of the smoking appliance by the processing chip after unbinding.

11. A computer-readable memory medium comprising, one or more instructions are stored in the computer-readable memory medium, when the one or more instructions are executed by the processor in the terminal, the anti-counterfeiting and encryption system method of the cartridge according to claim 6 is realized.

12. An aerosol generating device comprising:
a memory and a processor;
at least one program instruction stored in the memory;
the processor realizes the anti-counterfeiting and encryption method of the cartridge according to claim 6 by loading and executing the at least one program instruction.
